(19) United States
(12) Patent Application Publication
(10) Pub. No.: US 2025/0217631 A1
(43) Pub. Date: Jul. 3, 2025

(54) Deep Learning System for Casing Centralization Estimation Through Pulse-Echo TIE Interference

(71) Applicant: Schlumberger Technology Corporation, Sugar Land, TX (US)

(72) Inventors: Izabela Leao, Vauhallan (FR); Hiroshi Hori, Châtillon (FR); Roel Van Os, Bourg-la-Reine (FR)

(21) Appl. No.: 18/399,165

(22) Filed: Dec. 28, 2023

(51) Int. Cl. G06N 3/0464; E21B 47/002; G06N 3/096

(52) U.S. Cl. CPC G06N 3/0464; E21B 47/0025; G06N 3/096; E21B 2200/22

(57) ABSTRACT

Methods and apparatus to analyze data related to ultrasonic images. The method can include selecting a training dataset and generating labels and classes from the selected training dataset. The method can also include obtaining a model through artificial intelligence from a pretrained computer model, the selected training dataset and the generated labels and classes. The method can further include using the obtained model to evaluate eccentering from the ultrasonic images and obtaining ultrasonic images related to a downhole environment The method also includes determining a recipe to score a set of the ultrasonic images of the downhole environment and using the recipe to score and select a resulting dataset of ultrasonic images and updating the training dataset with the resulting dataset of ultrasonic images.

### BACKGROUND OF THE DISCLOSURE

Inner tubulars are placed in oil and gas production wells as a conduit of hydrocarbon, to securely lift it from downhole reservoir to the surface production system. When hydrocarbon production comes to an end, oil and gas wells are plugged by cement, sometimes removing the inner tubulars and casings to seal hydrocarbon passing from the reservoir. Well conditions, including cement and casing qualities, are utilized to perform casing cutting and cementing operations of the wells, known as plugging and abandonment.

### SUMMARY OF THE DISCLOSURE

The present disclosure introduces aspects for determining eccentricity and orientation of an inner tubular (e.g., tubing, liner, inner casing, etc.) in an outer casing using pulse-echo signals that are acquired in, for example, a dual-string cased well.

### BRIEF DESCRIPTION OF THE DRAWINGS

The present disclosure is understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of an example implementation of apparatus according to one or more aspects of the present disclosure.

FIG. 2 is a schematic view of at least a portion of an example implementation of apparatus according to one or more aspects of the present disclosure.

FIG. 3 is a schematic view of at least a portion of an example implementation of apparatus according to one or more aspects of the present disclosure.

FIGS. 4a and 4b are schematic views of ultrasonic wave reflection and transmission responses in a dual-string cased hole.

FIG. 5 depicts an example set of model signals according to one or more aspects of the present disclosure.

FIGS. 6a-6d partially depict an example of forward modeling as time-lapsed acoustic pressure signal excitations in dual-strings.

FIGS. 7a and 7b depict example VDL images showing ultrasonic signals acquired in a dual-string test well.

FIGS. 8a-8c depict different beam patterns that can be generated with a phased-array module pertaining to one or more aspects of the present disclosure.

FIG. 9 is a flow-chart diagram of at least a portion of an example implementation of a classification architecture according to one or more aspects of the present disclosure.

FIG. 10 is a flow diagram according to one or more aspects of the present disclosure.

FIGS. 11 and 12 are example VDL images depicting one or more aspects of the present disclosure.

FIG. 13 is a schematic view of at least a portion of an example implementation of apparatus according to one or more aspects of the present disclosure.

### DETAILED DESCRIPTION

It is to be understood that the following disclosure provides many different embodiments, or examples, for implementing different features of various embodiments.

Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

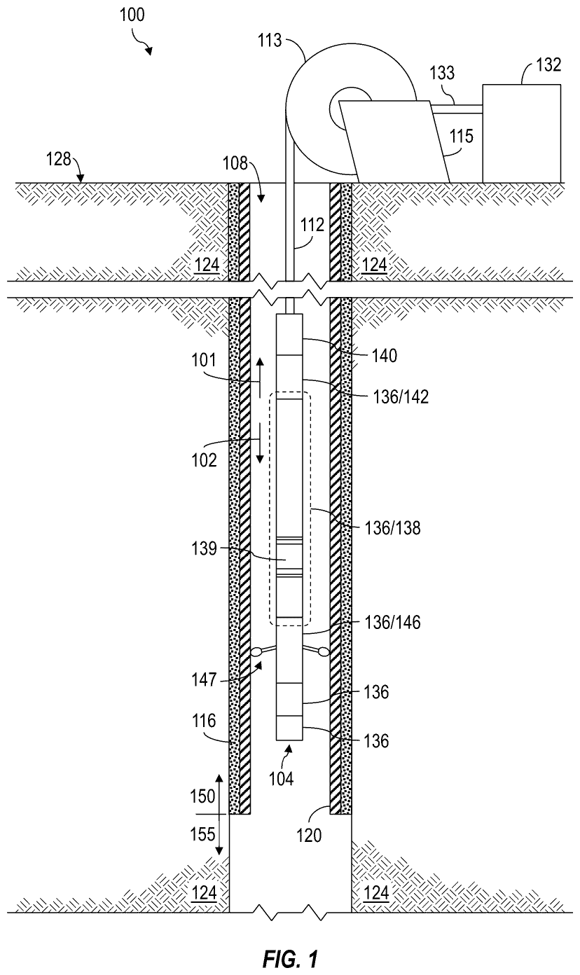

FIG. 1 is a schematic view of at least a portion of an example implementation of a wellsite system 100 to which one or more aspects of the present disclosure may be applicable.

The wellsite system 100 may be onshore (as depicted) or offshore. In the example wellsite system 100 shown in FIG. 1, a tool string 104 is conveyed in a borehole 108 via a wireline, slickline, and/or other conveyance means 112. The example wellsite system 100 may be utilized for evaluation of the borehole 108, cement 116 securing casing 120 within the borehole 108, a tubular (not shown) secured in the casing 120 (e.g., production services tubing), and/or a subterranean formation 124 penetrated by the borehole 108 in cased 150 or/and open hole 155 sections. The major part of the wellbore is shown as a “cased wellbore” but may be open hole (without cement or casing secured to the formation).

The tool string 104 is suspended in the borehole 108 from the lower end of the conveyance means 112. The conveyance means 112 may be a single- or multi-conductor slickline or wireline logging cable spooled on a drum 113 of a winch 115 at the surface 128 of the wellsite from whence the borehole 108 extends. The wellsite surface 128 is the generally planar surface of the terrain (i.e., Earth's surface), a floor of a rig (not shown) at the wellsite, or other equipment at the wellsite, which is perpendicularly penetrated by the borehole 108.

Operation of the winch 115 rotates the drum 113 to reel in the conveyance means 112 and thereby pull the tool string 104 in an uphole direction 101 in the borehole 108, as well as to reel out the conveyance means 112 and thereby move the tool string 104 in a downhole direction 102 in the borehole 108. The conveyance means 112 may include at least one or more conductors (not shown) that facilitate data communication between the tool string 104 and surface equipment 132 disposed at the wellsite surface 128, including through one or more slip rings, cables, and/or other conductors (schematically depicted in FIG. 1 by reference number 133) electrically connecting the one or more conductors of the conveyance means 112 with the surface equipment 132. The conveyance means 112 may alternatively transport the tool string without a conductor inside the cable but with at least one module that can autonomously acquire and/or process and/or store downhole measurements in downhole memory without human intervention or communication with the surface equipment 132.

Although not illustrated as such in FIG. 1, the winch 115 may be disposed on a service vehicle or a stationary skid/platform. The service vehicle or stationary skid/platform may also contain at least a portion of the surface equipment 132.

The tool string 104 comprises a plurality of modules 136, one or more of which may comprise an elongated housing and/or mandrel carrying various electronic and/or mechanical components. For example, at least one of the modules 136 may be or comprise at least a portion of a device for measuring a feature and/or characteristic of the borehole 108, the casing 120, a tubular installed in the casing 120 (not shown), the cement 116, and/or the formation 124, and/or a device for obtaining sidewall or inline core and/or fluid (liquid and/or gas) samples from the borehole 108 and/or formation 124. Other implementations of the downhole tool string 104 within the scope of the present disclosure may include additional or fewer components or modules 136 relative to the example implementation depicted in FIG. 1.

The wellsite system 100 also includes a data processing system that may include at least a portion of one or more of the surface equipment 132, control devices and/or other electrical and/or mechanical devices in one or more of the modules 136 of the tool string 104 (such as a downhole controller 140), a remote computer system (not shown), communication equipment, and/or other equipment. The data processing system may include one or more computer systems or devices and/or may be a distributed computer system. For example, collected data or information may be stored, distributed, communicated to a human wellsite operator, and/or processed locally (downhole or at surface) and/or remotely.

The data processing system may, whether individually or in combination with other system components, perform the methods and/or processes described below, or portions thereof. For example, the data processing system may include processor capability for collecting caliper, acoustic, ultrasonic, and/or other data related to the evaluation of the cement 116, the casing 120, a tubular installed in the casing 120 (not shown), and/or the formation 124, according to one or more aspects of the present disclosure. Methods and/or processes within the scope of the present disclosure may be implemented by one or more computer programs that run in a processor located, for example, in one or more modules 136 of the tool string 104 and/or the surface equipment 132. Such programs may utilize data received from the downhole controller 140 and/or other modules 136 and may transmit control signals to operative elements of the tool string 104, where such communication may be via one or more electrical or optical conductors of the conveyance means 112. The programs may be stored on a tangible, non-transitory, computer-usable storage medium associated with the one or more processors of the downhole controller 140, other modules 136 of the tool string 104, and/or the surface equipment 132, or may be stored on an external, tangible, non-transitory, computer-usable storage medium that is electronically coupled to such processor(s). The storage medium may be one or more known or future-developed storage media, such as a magnetic disk, an optically readable disk, flash memory, or a computer-readable device of another kind, including a remote storage device coupled over one or more wired and/or wireless communication links, among other examples.

As designated in FIG. 1 by reference number 138, at least one of the modules 136 may be or comprise a acoustic or ultrasonic tool operable for acquiring acoustic or ultrasonic pulse-echo signals for characterizing the borehole 108, the casing 120, a tubular installed in the casing 120 (not shown), the cement 116, the formation 124, etc, at more than one circumferential position or azimuth of the borehole, while mechanically rotating at least one ultrasonic transducer or alternatively an electrically driven ultrasonic phased-array transducer (139), at azimuthal directions relative to the azimuthal tool reference referred as a tool face or tool key (141). Time and the azimuthal directions of the pulse echo signal acquisitions are controlled by the tool (138) and recorded together with the signals to map measured data to borehole azimuth and depth. The one or more modules 136 may also include an orientation module permitting measurement of the azimuth of the tool 138. Such module may include, for example, one or more of relative bearing (RB) or gravity/acceleration, magnetometer and gyroscope sensors.

As designated in FIG. 1 by reference number 146, another one (or more) of the modules 136 may be or comprise a centralizer module. For example, the centralizer module 146 may comprise an electric motor driven by a controller (neither shown) and/or other means for actively extending (“opening”) and retracting (“closing”) a plurality of centralizing arms 147. Although only two centralizing arms 147 are depicted in the example implementation shown in FIG. 1, other implementations within the scope of the present disclosure may have more than two centralizing arms 147. Extension of the centralizing arms 147 aids in urging the acoustic or ultrasonic tool 139 to a central position within the casing 120, another tubular, or the borehole 108 being investigated by the acoustic or ultrasonic tool 139. Implementations of tool strings within the scope of the present disclosure may include more than one instance of the acoustic or ultrasonic tool 139 and/or more than one instance of the centralizer module 146. The modules 136 may be conveyed in either or both of open hole 150 and cased hole 155 sections, including implementations in which the centralizer module 146 and the acoustic or ultrasonic module 139 may be configured or configurable for use in either or both of the two sections. The tool string 104 may also be deprived of centralizer module 146. The centralizing arms (147) depicted in FIG. 1 is just an example implementation, which does not limit other alternative structures such as rubber standoffs or fins, or a ring-shape protrusion from the tool (146) in built-in or mechanically detachable form.

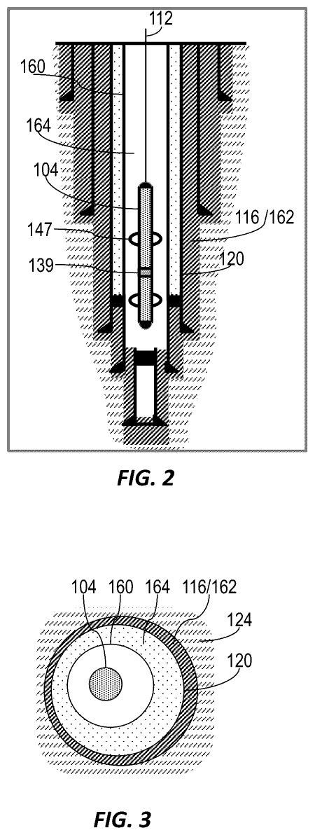

The equipment depicted in FIG. 1 may also be utilized in implementations in which the tool string 104 is conveyed within a tubing installed inside the casing 120, as depicted in FIGS. 2 and 3. In such implementations (among others), qualities of the cement, qualities of the inner and outer casings, and other well conditions are utilized to perform casing cutting and cementing operations of the wells, known as plugging and abandonment (P&A), among other purposes. For example, new technologies for dual-string P&A evaluation, such as combing sonic and ultrasonic measurements to identify cement quality of the outer-casing (so called B-annulus), is described in U.S. Pat. No. 10,138,727, the entirety of which is hereby incorporated herein by reference. Such technology utilizes ultrasonic casing flexural third interface echo (TIE) signals to provide inner tubular eccentricity. Ultrasonic casing flexural logging and TIE signal processing are also described in U.S. Pat. Pub. 2022/0146701, the entirety of which is hereby incorporated herein by reference. Availability of flexural logging data may be limited depending on cement evaluation services requested and availability of the measurements depending on casing dimensions. Moreover, in dual-string well with the annular material of high-density cement, that has its compressional wave propagation velocity faster than the inner tubular flexural wave propagation speed, the dominant flexural TIE signals propagate at the speed of shear wave speed of the cement, as it is taught in the prior art U.S. Pat. No. 7,522,471.

Measurement of the compressional wave propagation speed is no longer available from the flexural TIE signals in such high-density cement. On the other hand, the pulse-echo TIE is propagating at compressional velocity in such high-density cement. Compressional wave propagation speed measurement becomes uniquely available from the pulse-echo measurement in the high-density cement.

FIG. 2 is a schematic sectional view of at least a portion of an example implementation in which the tool string 104 is deployed within a tubular 160 that has been installed within the casing 120. Although not depicted in FIG. 2, one of the modules 136 of the tool string 104 is a pulse-echo tool that receives signals from the tubular 160 and the casing 120.

FIG. 3 is an axial view of the casing 120, the tubular 160 within the casing 120, and the tool string 104 within the tubular 160. FIGS. 2 and 3 each depict an outer annulus (B-annulus) 162 defined between the casing 120 and the formation 124 and filled with cement 116, as well as an inner annulus (A-annulus) 164 defined between the casing 120 and the tubular 160. The materials in the inner the outer annuli (164, 116) may be one of followings but are not limited to, cement, fluid, hydrates, gels, segregated solid of drilling mud or solid of collapsed formation (124) depending on wells and their depth intervals.

Alternative to conventional cement-evaluation tools [e.g. PowerEcho or PowerFlex], a cement evaluation tool using a phased-array ultrasonic transducer (e.g., having one or more aspects as described in U.S. Pat. Pub. 2021/0247538 and/or U.S. Pat. Pub. 2021/0311224, the entireties of which are hereby incorporated herein by reference) can provide pulse-echo measurements in tubulars and casings. As for the conventional tools, pulse-echo measurements of such a phased-array cement evaluation tool provides ultrasonic cement evaluation, which can be combined with sonic measurements (e.g., according to one or more aspects described in U.S. Pat. No. 9,927,541, the entirety of which is hereby incorporated by reference) to provide cement evaluation service in dual-string wells.

In the context of the present disclosure, a cement evaluation tool (or others) is conveyed within the inner tubular and receives signals from the tubular and the outer casing or formation surrounding the inner tubular. The present disclosure also relates to an image classification system designed, using deep learning techniques, to automatically estimate the eccentering distance and azimuth/phase of the innermost casing/tubing, using ultrasonic amplitude images that contain TIE interference. A Keras neural network model may be trained using synthetically generated ultrasonic waveforms for each azimuth and distance combination as training data. Ultrasonic field results may then be used as validation data.

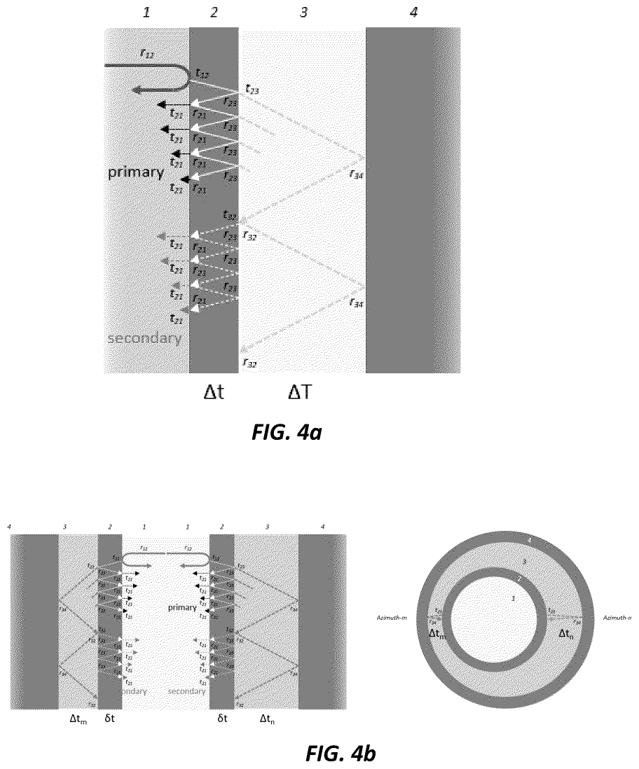

When pulse-echo measurements are conducted in a dual-string cased hole in the inner tubular, one can observe outer casing echo in time-series, super-imposed on inner casing pulse-echo responses. FIG. 4a is a schematic illustration of ultrasonic wave reflection and transmission responses in a dual-string cased hole. In FIG. 4a, the letters “r” and “t” respectively correspond to reflection and transmission. Two subscript numbers at the foot of “r” and “t” each indicate a material index at material boundaries. Materials 1, 2, 3, and 4 are respectively fluid (inside the inner tubular 160), steel (of the inner tubular 160), cement 116 (in A-annulus 162), and steel (of the outer casing 120), respectively shown in different colors of intermediate gray, dark gray, light gray, and dark gray. Material number 4 can also refer to the subterranean formation. The gradation at the right and left edges indicates material continuities at the boundaries. Capital letters “R” and “T” identify acoustic signals excited as a result of reflection and transmission, and following numbers indicate the interface of two different materials that causes the reflection (R) and transmission (T) events.

When the ultrasonic transducer of the downhole tool emits an ultrasonic signal toward the fluid-filled inner tubular wall, the signal will be reflected at the fluid/steel boundary due to the presence of acoustic impedance contrast, at reflection coefficient represented as r12. A part of the signal is transmitted into the inner tubular casing (T23) and then reflected at the casing/cement interface (R23). The ultrasonic signal inside the inner tubular is repeatedly reflected back and forth (R21, R23), which is observed as a train of signals (T21) as the tubular thickness resonance. Multiple reflections (R) and transmission (T) events are illustrated with vertically offset proportional to its time-lapse for the sake of visualization, but the actual events along the radial directions happen at the angle of incidence, substantially close to the normal incidence to casing/fluid/cement interfaces. There will be reflection and transmission in both compressional (P-wave) and shear (S-wave) waves, but the P-component is dominating due to the normal incidence. The downhole tool uses these casing resonance signals (T21) to identify energy loss at the inner tubular/cement boundary, which can be inverted to acoustic impedance using, for example, the methods described in the U.S. Pat. Nos. 5,216,638 and/or 10,345,465, the entire disclosures of which are hereby incorporated herein by reference. Inner tubular thickness can be determined from the two-way reflection time &t inside the inner tubular, such as via the inverse of casing resonance frequency of returned signals T21 disclosed in U.S. Pat. No. 5,216,638.

The wave transmitted into cement (T23) will be reflected back and forth at cement/steel boundaries (2-3 and 3-2) and transmitted back to the inner tubular (T32). Outer casing reflection (R34) hits the inner tubular, and then excites the inner tubular resonance at the same frequency of inner tubular thickness resonance, although possibly at a different phase from the primary excitation T12, depending on the travel time Δt in the A-annulus. When the inner tubular 160 is eccentered relative to the outer casing 120, the travel time Δt in the A-annulus will have azimuthal dependency. The time delay from the inner tubular specular echo to the first outer casing arrival is two-way traveling time in the inner tubular (2×δt) plus two-way traveling time in the A-annulus (2×Δt). at the compressional velocity (Vp) of the annular material 164.

FIG. 4b is a schematic view of eccentered dual-strings relative to each other. The figure in the left presents the radius-axis cross-section view at eccentering orientation. The inner tubular is eccentered toward the left or azimuth-m. The shortest and largest travel time in the A-annulus is respectively at azimuth-m and azimuth-n, where azimuth-m is 180 degrees apart from azimuth-n.

When the tool is nearly centered in the inner tubular, signals from the outer casing will be maximized in their amplitude at the azimuth of eccentering orientation. When the inner tubular eccentering is relatively small, A-annulus travel time (Δt) will have a sinusoid profile, having the minimum and maximum at the respective azimuth indices, m and n. When the eccentricity increases azimuthal profile may deviate from sinusoid, dilatated and compressed respectively toward azimuth-m and n. Prediction of azimuthal profile of Δt is possible using ray-tracing technique, or more precisely using forward modeling, such as finite difference, finite element, spectral element, semi-analytical modeling, or modeling software combining such techniques.

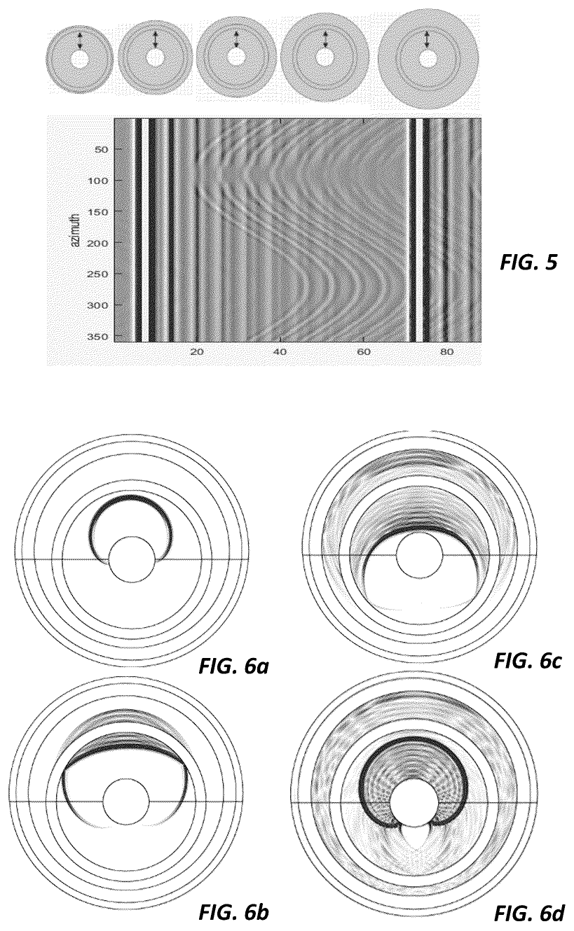

FIG. 5 depicts an example set of model signals while rotating the firing directions in the dual-strings in eccentered conditions, using semi-analytical modeling (e.g., according to one or more aspects described in “Analytical modeling for fast simulations of ultrasonic measurements on fluid-loaded layered elastic structures,” S. Zeroug, IEEE Transactions on Ultrasonics, Ferroelectrics, and Frequency Control, vol. 47, no. 3, pp. 565-574, May 2000, doi: 10.1109/58.842043). Simulated signals in one turn are presented in variable density log (VDL) like image. The vertical and horizontal axes are respectively azimuth (unit in degree) and time step. Vertical light/dark stripes show the inner tubular resonance that decays as a function of time, radiating the acoustic energy out of the casing. Light/dark sinusoidal stripes super-imposed onto the vertical stripes are the outer casing echo that excited the inner tubular resonance. The example simulated signals were not from the model geometry of exact dual-string in eccentered, instead using simplified geometry varying the inner radius of the external casing that mimics the distance variation caused by eccentering. Precise model data can be simulated using finite element modeling.

An example of forward modeling of COMSOL, is partially depicted in FIGS. 6a-6d as time-lapsed acoustic pressure signal excitations in dual-strings. One pressure source excites ultrasonic signal toward the top side of the inner tubular that is eccentered toward the bottom side of the image. From simulated time-domain signals in 2-D plane, one can generate synthetic pulse-echo signals that is identical to the measurements. Repeating such simulations over multiple different azimuths referring to the eccentering direction, one can generate a set of waveforms simulating the actual pulse-echo signals acquired by the tool in dual-strings in eccentered conditions.

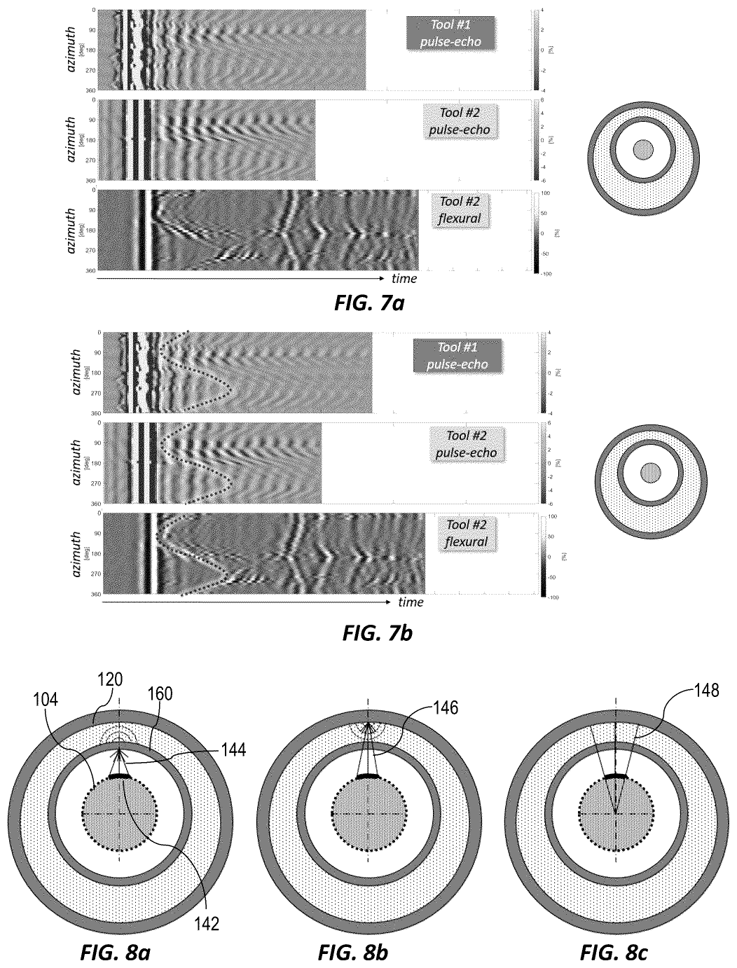

In the actual tool measured signals, inner tubular echo and casing resonances tend to appear as nearly vertical lines when the signals are aligned referring inner casing echo, while outer casing echo from its inner radius will present sinusoidal arrival time variation when two tubulars are eccentered with respect to each other. FIG. 7a depicts example VDL images showing ultrasonic signals acquired in a dual-string test well, using two different tools. Both tool #1 and tool #2 perform pulse-echo ultrasonic measurements. Tool #2 also delivers an ultrasonic flexural pitch-catch measurement. The three VDL images from the top to bottom respectively the pulse-echo measurement from tool #1, the pulse-echo measurement from tool #2 and the flexural pitch-catch measurement from tool #2. In each image, the horizontal and vertical axes are respectively waveform time (unit: μs) and azimuthal transducer direction in a tubular from 0 to 360 degrees. The strongest signals, in high contrast light and dark stripes, near the time of 10 us are the specular echo or direct reflections at the fluid/steel boundary in the inner tubular for the pulse-echo images, and inner tubular flexural waves that are refracted back to the PC receiver transducer The outer casing arrivals at the earliest and latest times can be seen near the times of about 16 and 36 us in the pulse-echo images, and at about 20 and 72 us in the flexural image, respectively at the azimuth of about 90 and 270 degrees. The signals were acquired in a water-filled inner tubular that was cemented in an outer-casing at the controlled eccentricity of a test well, A-annulus material was cement.

FIG. 7b depicts the images of FIG. 7a with dashed lines indicating outer casing echo signals. The horizontal axis of the flexural VDL is compressed in the way that sinusoidal arrival times of the outer casing echo shapes matched to that of the pulse-echo signals. One or more aspects introduced in the present disclosure may be utilized to automatically estimate the inner tubular eccentering direction and its magnitude, even when the flexural measurement is not available.

Another aspect of this invention is to use an ultrasonic phased array 140 different focusing to enhance the outer casing signals. FIGS. 8a, 8b and 8c illustrate the tool 104 virtually centered in the inner tubular. In downhole, the phased array module 139 may be eccentered in inclined wells, however, the phased array tool 139 can estimate and recover ultrasonic beam pattern as disclosed in U.S. Pat. Pub. 2021/0247538 and/or U.S. Pat. Pub. 2021/0311224. FIG. 8a presents a part of phased array 142 is emitting acoustic pulses 144 focused at the inner surface of the inner tubular (160). Focused beam will minimize the inner tubular ringing and transmit signals in A-annulus in spherical waves, and echo from the outer casing 120 inner surface can be enhanced. FIG. 8b illustrates the phased array beam 146 focused at the inner surface of the outer casing 120. FIG. 8c illustrates the ultrasonic beam 148 excited from a group of phased array elements 142 nearly at normal incidence to the outer casing surface. Inner tubular 60 resonance will be energetically excited, so as the outer casing 120 echo signals that will be in-phase among the group of the elements 142. The best beam pattern to identify casing eccentricity and wave propagation speed of annular material, is a part of the phased array tool 139 operational parameters, that can be varied in desired manner, either or both for signal emission and reception, dependent on annular material and geometrical parameters of the tool/inner tubular/outer casing.

### Classification System

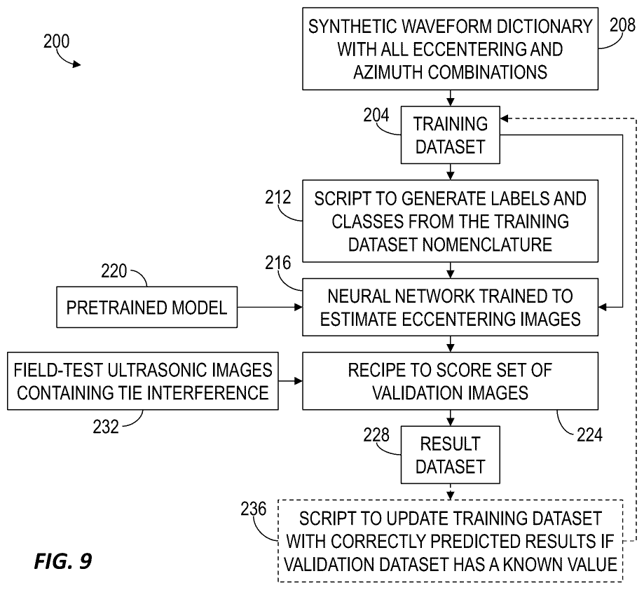

FIG. 9 is a flow-chart diagram illustrating at least a portion of an example implementation of the classification architecture 200. The original training dataset 204 is fed with a synthetic waveform dictionary 208 with all eccentering-distance and azimuth combinations. The dictionary can be built using ray-path modeling, forward modeling, such as finite difference, finite element, spectral element, semi-analytical modeling, or modeling software combining such techniques. After the training dataset 204 has been processed by a classifier script 212, labels and classes are automatically detected and used to construct the neural network model 216. Each class corresponds to a level of eccentricity.

An existing deep learning model can be retrained with new images using a pretrained model 220, such as the Keras API, which applies transfer learning (with fine-tuning) methods, thus avoiding having to retrain convolutional layers completely, thereby saving computational resources. The system 216 is then used to determine 224 the eccentering distance and azimuth/phase 228 of measured ultrasonic images 232 containing sinusoids produced by TIE interference (Third Interface Echo), in which learning and classification are based on the differences in the casing resonance amplitude for different eccentering values. For datasets with known eccentering and phase, a recursive script 236 may be run to process the model results 228 and feed them into the training dataset 204, thus dynamically increasing the learning capacity.

### Application Example

To build a deep learning system from existing models, the Dataiku Data Science Studio (DSS) may be utilized to create an AI workflow. By testing the deployment model against 10% of the training dataset, the image classification plugin automates the validation process. This model may be pre-trained using Xception, a deep learning convolutional neural network (CNN) architecture based on Depthwise Separable Convolutions.

The eccentering classification is based on the estimation of the amplitude of the TIE interference sinusoid. Therefore, data augmentation techniques which may distort the image are excluded from the training, including pooling, layers to retrain, dropout, regularization, optimization, and training settings. The Adam algorithm may be utilized as an optimizer tool with the standard learning rate. The number of epochs may be set to 10, for example, where epoch is the hyperparameter of gradient descent that sets the number of complete passes through the training dataset, with a certain number of validation steps. There may be 50 validation steps per epoch, for example.

The training dataset includes a synthetically generated dictionary of azimuthal sets of artificial waveforms from a semi-analytic modeling method, containing numerous (e.g., 400) simulated waveforms for different cement thickness behind the casing. The length of each waveform may be 512 samples, with eccentering values or eccentricity ranging from 0 to 100%, for 360 azimuthal positions mapping the matrix. Eccentricity is defined as the percentage ratio of the inner tubular radial displacement to the concentric dual-pipe annular spacing, which is the distance between the outer surface of the inner tubular and the inner surface of the outer casing. Dual pipes are concentric or contacting each other, respectively at the eccentricity of 0 and 100%. In this invention, numbers of training dataset, such as number of simulation and resulting waveforms, length of each waveform, eccentricity values and azimuthal directions are merely examples to disclose this invention, which do not limit using different values.

In order to classify the TIE interference phenomenon, the validation dataset comes from an dual-string well, signals logged using an ultrasonic tool at different depths, denoted here as increasing frame numbers. The annular space between the inner tubular and the outer casing is filled with a standard class-G cement. The outer diameters of the inner tubular and the outer casing are respectively 7 and 9⁵/8 inches. In this specific example, the placement of the inner tubular inside the second casing represents an eccentricity of 69%. The method concentrates on finding this eccentering value, as well as its direction with respect to the tool or transducer reference azimuth.

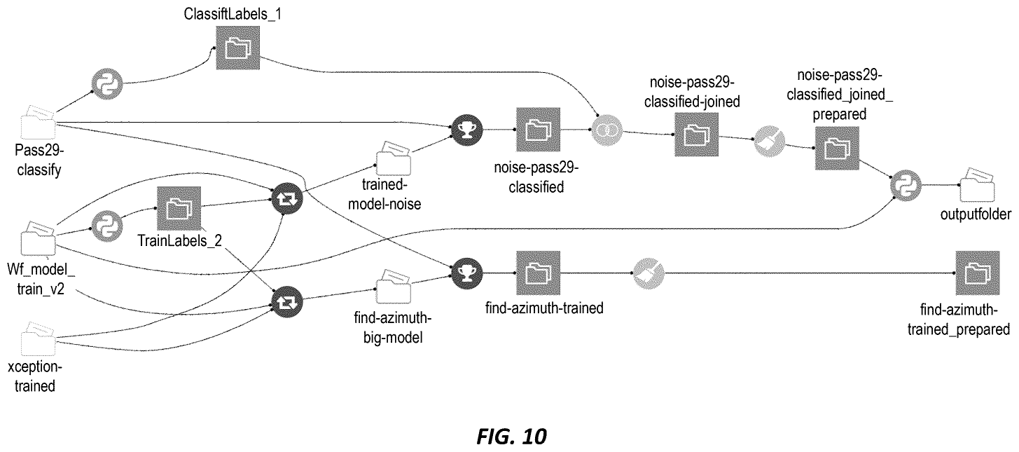

For a better concentration on the modulation caused by the TIE, a section of a VDL image may be generated excluding the specular echo of the inner tubular. This section VDL images from different depth frames may then be classified after the layers of the neural network that are trained and validated. For the prediction of the eccentricity of each depth frame, a probability or confidence level may be scored between 0 and 1 (or between 0 to 100%). FIG. 10 illustrates an example workflow diagram.

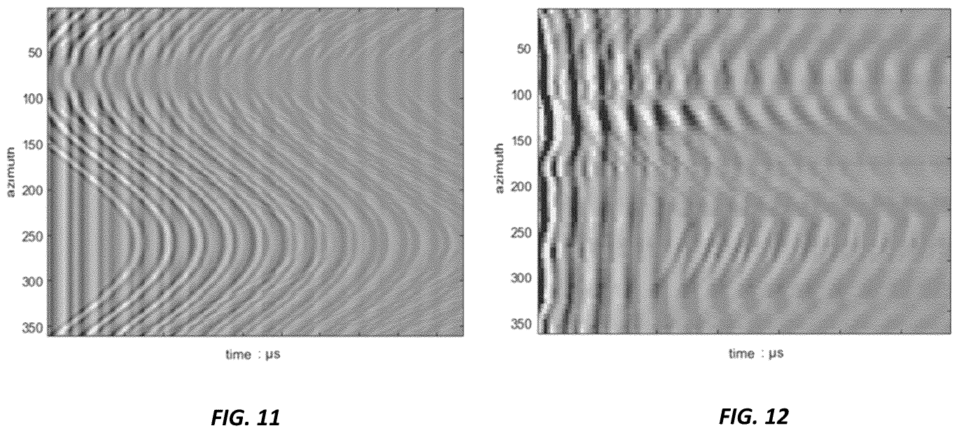

Table 1 presents the scored confidence levels of predicted eccentricity from 91 section images from corresponding depth frames. The section images (such as shown in FIGS. 11 and 12) are generated from pulse-echo waveforms and are similar to those presented in FIG. 7. With a very high degree of confidence, the trained neural network predicted an accurate eccentricity of 69%, as tabulated in Table 1.

TABLE 1
Eccentering estimation and percentage of confidence
of 91 depth frames computed by the Xception model

| FR_NR | ECC | CONF |
|---|---|---|
| 1 | 69 | 99% |
| 2 | 69 | 99% |
| 3 | 69 | 100% |
| 4 | 69 | 100% |
| 5 | 69 | 100% |
| 6 | 69 | 99% |
| 7 | 69 | 98% |
| 8 | 69 | 99% |
| 9 | 69 | 99% |
| 10 | 69 | 100% |
| 11 | 69 | 99% |
| 12 | 69 | 100% |
| 13 | 69 | 99% |
| 14 | 69 | 99% |
| 15 | 69 | 96% |
| 16 | 69 | 94% |
| 17 | 69 | 94% |
| 18 | 69 | 99% |
| 19 | 69 | 99% |
| 20 | 69 | 99% |
| 21 | 69 | 99% |
| 22 | 69 | 96% |
| 23 | 69 | 90% |
| 24 | 69 | 93% |
| 25 | 69 | 93% |
| 26 | 69 | 94% |
| 27 | 69 | 90% |
| 28 | 69 | 85% |
| 29 | 69 | 97% |
| 30 | 69 | 93% |
| 31 | 69 | 90% |
| 32 | 69 | 94% |
| 33 | 69 | 87% |
| 34 | 69 | 93% |
| 35 | 69 | 89% |
| 36 | 69 | 81% |
| 37 | 69 | 85% |
| 38 | 69 | 68% |
| 39 | 69 | 93% |
| 40 | 69 | 99% |
| 41 | 69 | 99% |
| 42 | 69 | 100% |
| 43 | 69 | 99% |
| 44 | 69 | 89% |
| 45 | 69 | 82% |
| 46 | 69 | 99% |
| 47 | 69 | 97% |
| 48 | 69 | 99% |
| 49 | 69 | 95% |
| 50 | 69 | 98% |
| 51 | 69 | 98% |
| 52 | 69 | 99% |
| 53 | 69 | 97% |
| 54 | 69 | 88% |
| 55 | 69 | 99% |
| 56 | 69 | 99% |
| 57 | 69 | 97% |
| 58 | 69 | 98% |
| 59 | 69 | 98% |
| 60 | 69 | 93% |
| 61 | 69 | 98% |
| 62 | 69 | 100% |
| 63 | 69 | 99% |
| 64 | 69 | 99% |
| 65 | 69 | 97% |
| 66 | 69 | 94% |
| 67 | 69 | 99% |
| 68 | 69 | 99% |
| 69 | 69 | 96% |
| 70 | 69 | 96% |
| 71 | 69 | 99% |
| 72 | 69 | 100% |
| 73 | 69 | 100% |
| 74 | 69 | 100% |
| 75 | 69 | 99% |
| 76 | 69 | 100% |
| 77 | 69 | 99% |
| 78 | 69 | 100% |
| 79 | 69 | 99% |
| 80 | 69 | 99% |
| 81 | 69 | 100% |
| 82 | 69 | 100% |
| 83 | 69 | 100% |
| 84 | 69 | 100% |
| 85 | 69 | 100% |
| 86 | 69 | 100% |
| 87 | 69 | 100% |
| 88 | 69 | 100% |
| 89 | 69 | 100% |
| 90 | 69 | 100% |
| 91 | 69 | 100% |

The azimuthal position of the eccentering is predicted with a lower confidence interval, and only on a limited number of frames. The prediction provides an estimation of 77 degrees, which is very close the real azimuthal position estimated at 79 degrees.

At the end of the system workflow, a script selects the highest similarity from the dictionary based on the estimated eccentering and phase of the validation dataset. As an example, FIGS. 11 and 12 show the best match found for frame 43, namely the synthetic waveform VDL-image with 69% eccentering and a 77-degree shift. FIG. 11 depicts example synthetic waveforms presented as a VDL image with 69% of eccentering and a 77-degree shift. FIG. 11 depicts example section VDL image of pulse-echo signals logged at the depth frame number 43.

There are numerous methods for improving the learning of complex non-linear image features, including the evaluation of other AI structures, for example the use of ResNet, a deep residual neural network for image recognition. Working with a neural network using linear correlation of numerical data is also possible.

The dataset can be adjusted using techniques for standardizing image pre-processing, such as formalizing the mapping of data values to the color map, enhancing the outer casing TIE signals using “bin processing” disclosed in the prior art U.S. Pat. No. 5,859,811. Additional pre-processing may eliminate adverse implications of the tool's eccentering with respect to the inner tubular, aligning and normalizing the referring specular pulse-echo.

The exposed method may automatically perform domain adaptation, such as by removing time-consuming manual labeling tasks, as well as providing greater flexibility in the nature of each included training dataset. For example, the system can be fed with numerous acknowledged field results from pulse-echo tools, combined with an interactive inclusion of each result from the above-mentioned sonic cement evaluation tool, resulting in a robust model grounded by realistic outcomes.

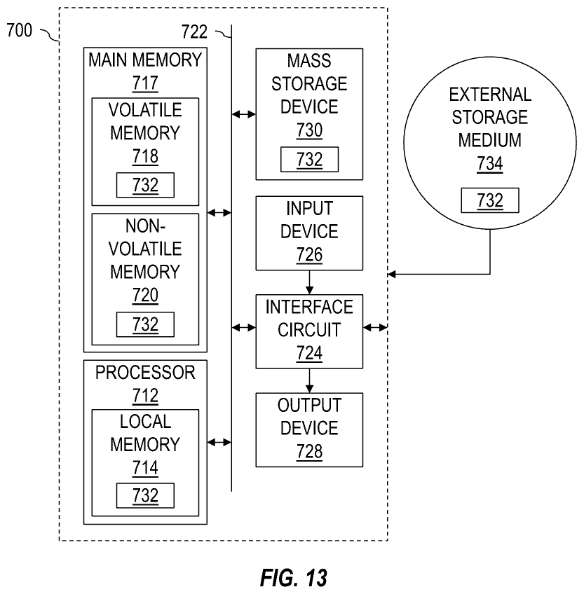

FIG. 13 is a schematic view of at least a portion of an example implementation of a processing system 700 according to one or more aspects of the present disclosure. The processing system 700 may execute machine-readable instructions to implement at least a portion of one or more of the methods and/or processes described herein, and/or to implement a portion of one or more of the example downhole tools and/or surface equipment described herein. The processing system 700 may be or comprise, for example, one or more processors, controllers, special-purpose computing devices, servers, personal computers, personal digital assistant (PDA) devices, smartphones, internet appliances, and/or other types of computing devices. The entirety of the processing system 700 may be implemented within downhole apparatus described above. One or more components or functions of the processing system 700 may also or instead be implemented in wellsite surface equipment, perhaps including the surface equipment 132 depicted in FIG. 1 and/or other surface equipment.

The processing system 700 may comprise a processor 712, such as a general-purpose programmable processor, among other examples. The processor 712 may comprise a local memory 714 and may execute program code instructions 732 present in the local memory 714 and/or another memory device. The processor 712 may execute, among other things, machine-readable instructions or programs to implement the methods and/or processes described herein. The programs stored in the local memory 714 may include program instructions or computer program code that, when executed by an associated processor, cause a controller and/or control system implemented in surface equipment and/or a downhole tool to perform tasks as described herein. The processor 712 may be, comprise, or be implemented by one or more processors of various types operable in the local application environment, and may include one or more general-purpose processors, special-purpose processors, microprocessors, DSPs, FPGAs, ASICS, processors based on a multi-core processor architecture, and/or other processors.

The processor 712 may be in communication with a main memory 717, such as via a bus 722 and/or other communication means. The main memory 717 may comprise a volatile memory 718 and a non-volatile memory 720. The volatile memory 718 may be, comprise, or be implemented by random access memory (RAM), static RAM (SRAM), dynamic RAM (DRAM), synchronous DRAM (SDRAM), RAMBUS DRAM (RDRAM), and/or other types of RAM devices. The non-volatile memory 720 may be, comprise, or be implemented by read-only memory, flash memory, and/or other types of memory devices. One or more memory controllers (not shown) may control access to the volatile memory 718 and/or the non-volatile memory 720.

The processing system 700 may also comprise an interface circuit 724. The interface circuit 724 may be, comprise, or be implemented by various types of standard interfaces, such as an Ethernet interface, a universal serial bus (USB), a wireless interface, and/or a cellular interface, among other examples. The interface circuit 724 may also comprise a graphics driver card. The interface circuit 724 may also comprise a communication device, such as a modem or network interface card, to facilitate exchange of data with external computing devices via a network, such as via Ethernet connection, digital subscriber line (DSL), telephone line, coaxial cable, cellular telephone system, and/or satellite, among other examples.

One or more input devices 726 may be connected to the interface circuit 724. One or more of the input devices 726 may permit a user to enter data and/or commands for utilization by the processor 712. Each input device 726 may be, comprise, or be implemented by a keyboard, a mouse, a touchscreen, a trackpad, a trackball, an image/code scanner, and/or a voice recognition system, among other examples.

One or more output devices 728 may also be connected to the interface circuit 724. One or more of the output devices 728 may be, comprise, or be implemented by a display device, such as a liquid crystal display (LCD), a light-emitting diode (LED) display, and/or a cathode ray tube (CRT) display, among other examples. One or more of the output devices 728 may also or instead be, comprise, or be implemented by a printer, speaker, and/or other examples.

The processing system 700 may also comprise a mass storage device 730 for storing machine-readable instructions and data. The mass storage device 730 may be connected to the interface circuit 724, such as via the bus 722. The mass storage device 730 may be or comprise a floppy disk drive, a hard disk drive, a compact disk (CD) drive, and/or digital versatile disk (DVD) drive, among other examples. The program code instructions 732 may be stored in the mass storage device 730, the volatile memory 718, the non-volatile memory 720, the local memory 714, and/or on a removable storage medium 734, such as a CD or DVD.

The mass storage device 730, the volatile memory 718, the non-volatile memory 720, the local memory 714, and/or the removable storage medium 734 may each be a tangible, non-transitory storage medium. The modules and/or other components of the processing system 700 may be implemented in accordance with hardware (such as in one or more integrated circuit chips, such as an ASIC), or may be implemented as software or firmware for execution by a processor. In the case of firmware or software, the implementation can be provided as a computer program product including a computer readable medium or storage structure containing computer program code (i.e., software or firmware) for execution by the processor.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same functions and/or achieving the same benefits of the embodiments introduced herein. A person having ordinary skill in the art should also realize that such equivalent constructions do not depart from the spirit and scope of the present disclosure, and that they may make various changes, substitutions, and alterations herein without departing from the spirit and scope of the present disclosure.

What is claimed is:

1. A method to analyze data related to ultrasonic images, comprising:
selecting a training dataset;
generating labels and classes from the selected training dataset;
obtaining a model through artificial intelligence from a pretrained computer model, the selected training dataset and the generated labels and classes;
using the obtained model to evaluate eccentering from the ultrasonic images;
obtaining ultrasonic images related to a downhole environment;
determining a recipe to score a set of the ultrasonic images of the downhole environment;
using the recipe to score and select a resulting dataset of ultrasonic images; and
updating the training dataset with the resulting dataset of ultrasonic images.

2. The method according to claim 1, wherein the selecting of the training dataset is from a synthetic waveform dictionary.

3. The method according to claim 2, wherein the synthetic waveform dictionary has eccentering and azimuth combinations.

4. The method according to claim 1, wherein the model obtained through artificial intelligence is a neural network.

5. The method according to claim 1, wherein the ultrasonic images are from a field operation.

6. The method according to claim 1, further comprising updating the training dataset using the resulting dataset of ultrasonic images.

7. The method according to claim 1, further comprising saving the updated training dataset in a non-volatile memory.

8. The method according to claim 1, wherein the training dataset is pulse-echo data.

9. The method according to claim 1, wherein the training dataset includes third interface echo data.

10. An article of manufacture comprising a non-volatile memory, the non-volatile memory configured to store a list of instructions configured to be read by a computer, the list of instructions comprising a method to analyze data related to ultrasonic images, comprising:
selecting a training dataset;
generating labels and classes from the selected training dataset;
obtaining a model through artificial intelligence from a pretrained computer model, the selected training dataset and the generated labels and classes;
using the obtained model to evaluate eccentering from the ultrasonic images;
obtaining ultrasonic images related to a downhole environment;
determining a recipe to score a set of the ultrasonic images of the downhole environment;
using the recipe to score and select a resulting dataset of ultrasonic images; and
updating the training dataset with the resulting dataset of ultrasonic images.

11. The article of manufacture of claim 10 wherein the non-volatile memory is configured as one of a mass storage device, a universal serial device, a solid-state device, a computer hard disk, a compact disk, and a computer server.

12. The method according to claim 11, wherein the training dataset includes third interface echo data.

13. The method according to claim 11, wherein the selecting of the training dataset is from a synthetic waveform dictionary.

14. The method according to claim 13, wherein the synthetic waveform dictionary has eccentering and azimuth combinations.

15. The method according to claim 11, wherein the model obtained through artificial intelligence is a neural network.

16. The method according to claim 11, wherein the ultrasonic images are from a field operation.

17. A method to analyze data related to ultrasonic images obtained from a downhole environment, the data including third interface echo information, the method comprising:
selecting an ultrasonic image training dataset;
generating labels and classes from the selected training dataset;
obtaining a model through artificial intelligence from a pretrained computer model, the selected training dataset and the generated labels and classes; using the obtained model to evaluate eccentering from the ultrasonic images;
obtaining ultrasonic field images related to a downhole environment;
determining a recipe to develop a score for analyzed images;
using the recipe to score and select a resulting analyzed dataset of ultrasonic images; and
updating the training dataset with the resulting dataset of ultrasonic images.

18. The method according to claim 16, wherein the model obtained through artificial intelligence is a neural network.

19. The method according to claim 16, wherein the selecting of the training dataset is from a synthetic waveform dictionary.

20. The method according to claim 16, further comprising saving one of the updated training dataset in a non-volatile memory and displaying the updated training dataset.
